(19) United States
(12) Patent Application Publication
(10) Pub. No.: US 2006/0139747 A1
(43) Pub. Date: Jun. 29, 2006

(54) Microscope

(76) Inventors: Leander Dietzsch, Jena (DE); Ullrich Klarner, Jena (DE); Hans Tandler, Jena (DE); Hubert Wahl, Stadtroda (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 10/540,342

(22) PCT Filed: Nov. 28, 2003
(86) PCT No.: PCT/EP03/13456

§ 371 Date: Jan. 3, 2006

(30) Foreign Application Priority Data
Dec. 20, 2002 (DE) 102616639

(51) Int. Cl. G02B 21/00

(52) U.S. Cl. 359/368

(57) ABSTRACT

The invention is directed to a microscope comprising a base body or stand, a stage support, a guide for adjusting the stage support or an objective changer device with inserted objectives, and a stage for holding the object or specimen. In the microscope, a supporting cell is provided which is optimized with respect to material and rigidity and is connected to the stand rigidly but so as to be exchangeable. First assemblies for receiving, holding and adjusting the objective and second assemblies for positioning the object or specimen relative to the objective are arranged at the supporting cell. The first assemblies are designed as an objective changer device and/or as an objective focusing device, and the second assemblies comprise a stage support, a stage guide, and a stage.

### CROSS REFERENCE TO RELATED APPLICATIONS

This application claims priority of International Application No. PCT/EP2003/013456, filed Nov. 28, 2003 and German Application No. 102 61 663.9, filed Dec. 20, 2002, the complete disclosures of which are hereby incorporated by reference.

### a) FIELD OF THE INVENTION

The invention is directed to a microscope, in particular an optical microscope, and the mechanical construction thereof.

### b) DESCRIPTION OF THE RELATED ART

Microscopes of whatever type of construction, whether upright or inverted, have the function of generating a magnified image of an object that can be observed and recorded. During magnification, which can have values of up to 5000×, unwanted relative movements between the objective and the object to be magnified which can result, e.g., from building vibrations, are also magnified and lead to blurry images, loss of contrast and reduced resolution, especially at higher magnifications.

For this reason, the mechanically rigid dimensioning and construction of assemblies such as the objective, changer devices, e.g., for objectives, the stage holder and the focusing mechanism are crucial. In conventional microscope constructions, which are approximately E-shaped when viewed from the side, the entire stand is, in most cases, included in the optimization of rigidity during development and construction. This usually leads to an amassing of material also at locations which do not necessarily help to improve the dynamic behavior but which have a negative result with respect to cost and weight. Since the extent of modular expansion varies, dimensioning must be based on determined maximum requirements which in most cases rarely occur; this renders the basic variants more expensive and heavier. Specially shaped stands have been, and are still being, developed in order to take dimensioning into account, e.g., axiomat or bridge constructions in microscopes used for special purposes. However, with respect to devices which do not utilize motors, these stands are disadvantageous in technical respects relating to operation as a result of the support function of the supporting structure and often lead to a restricted object space and, therefore, to difficulties in handling and arranging the objects.

DE 42 31 470 A1 discloses a modular microscope system which has a combination microscope base body having a stand base, an upper stand part and an intermediate module with attachable binocular tube. The base body is a multiple-part frame construction provided with stop faces for the positioning of supports on which are arranged optical and/or mechanical and/or electrical or electronic assemblies that combine to form functional units. These supports may be fitted with optical components such as mirrors, lenses, diaphragms, or with a turret unit for changing components quickly. Further, an intermediate module having a tube lens can be provided and can be exchanged with other intermediate modules which also have a switchable and preadjustable Bertrand lens in addition to a tube lens, for example.

However, the disadvantages mentioned above cannot be overcome with this microscope system.

Further, U.S. Pat. No. 4,168,881 discloses a microscope with a modular construction. In this case, a plurality of modules can be exchanged or combined with one another. This microscope has a microscope stand on which the objective and the eyepiece are arranged at a distance from one another in lever-shaped holders which inhibit vibrations. The element carrying the eyepiece is arranged at a distance from the element carrying the objective, that is, without mutual contact therebetween, in order to prevent transmission of vibrations from the eyepiece to the objective, which could be generated particularly by the user making contact with the eyepiece. To a great extent, this eliminates the relative movements between the objective and the object which diminish image quality.

### OBJECT AND SUMMARY OF THE INVENTION

It is the primary object of the invention to minimize the influence of mechanical and thermal factors on the imaging quality and image transmission characteristics in a microscope, to improve the dynamic behavior of the mechanical assemblies and to achieve a microscope construction which saves on material and reduces costs.

According to the invention, this object is met in a microscope of the type indicated in the preamble of the first patent claim by the characterizing features of this patent claim. Further constructions and details of the invention are disclosed in the subclaims.

In order to achieve a good support of the cell at the stand, the supporting cell is rigidly connected to the stand at a plurality of projections serving as a support by suitable fastening means. It is advantageous when the fastening means are detachable so that it is possible to exchange the supporting cell if necessary. To achieve good damping of shocks and/or vibrations between the stand and the cell, it is advantageous when damping and/or vibration-isolating intermediate layers are arranged between the supporting cell and the contact surfaces of the projections of the stand. It may also be advantageous when the supporting cell is arranged at the stand in a springing manner.

In an advantageous construction, the first assemblies are designed as an objective changer device and, possibly, as an objective focusing device.

To enable a secure and precise arrangement of different objectives in the microscope beam path, it is advantageous when an objective changer device constructed as an objective turret is arranged at the supporting cell.

Further, according to an advantageous construction of the invention, the second assemblies advantageously comprise a stage support, a stage guide and a stage.

It is also advantageous when the supporting cell is optimized with respect to rigidity, use of material, dimensioning and thermal behavior while adhering to requirements for high stability and optical transmission quality of the microscope.

To achieve optimal illumination of the object, it is advantageous that means for arranging a condenser are provided at the stage support.

In order to adjust the sharpness of the object by displacing the object stage relative to the objective, the stage guide has a guide plate that is fixedly arranged at the supporting cell and guide elements at the stage support which are in an operative connection with the guide plate.

To minimize the effects of thermal factors on the imaging quality of the microscope, the supporting cell advantageously comprises a thermally invariant material or other suitable material or a combination of such materials.

Because of the dimensioning of the supporting cell connecting the first elements with the second elements, material is saved or is used only where it is necessary for improved results. The other components of conventional microscope stands can be less refined with respect to supporting functions to the extent that larger open spaces are introduced for reducing weight, more expensive materials are avoided, and the rest of the stand is tailored to holding functions and functions for realizing the tolerances of the assemblies relative to one another.

This rigorous separation between supporting components and holding components results in appreciably higher resonant frequencies of the supporting cell and, therefore, in smaller amplitudes of the relative movements between the objective and object, and in a shorter decay time for amplitudes with comparable interference functions in the form of shock excitations on the microscope body.

Another advantage consists in that material can also be substituted in the supporting cell with minimized dimensions for further dynamic and thermal optimization. For example, ceramic materials, sintered materials or other suitable materials which are thermally invariant to a great extent can also be used.

Further, because of its compact construction, the supporting cell can also be used in expanded stands with vibration damping and without restriction. Therefore, not only must external excitations be separated, but also internal dynamic interference brought about by masses, e.g., existing drives, must be reduced.

The supporting cell combines the tolerance-critical basic assemblies of the microscope to form a stable unit. These assemblies include the holder for the objective, the objective turret, the assemblies serving to receive the object, guides for focusing the objective or object, and also the holder for the condenser. All other assemblies that do not belong to a microscope, e.g., for the power supply, transmitted illumination and incident illumination, and for tubes, if any, are held in a separate stand.

The invention will be described more fully in the following with reference to an embodiment example.

### BRIEF DESCRIPTION OF THE DRAWINGS

In the drawings:

FIG. 1 is a simplified view of an upright microscope with a supporting cell;

FIG. 2 is a simplified view of an inverted microscope with a supporting cell; and

FIG. 3 shows the arrangement of a supporting cell at the stand of a microscope.

### DESCRIPTION OF THE PREFERRED EMBODIMENTS

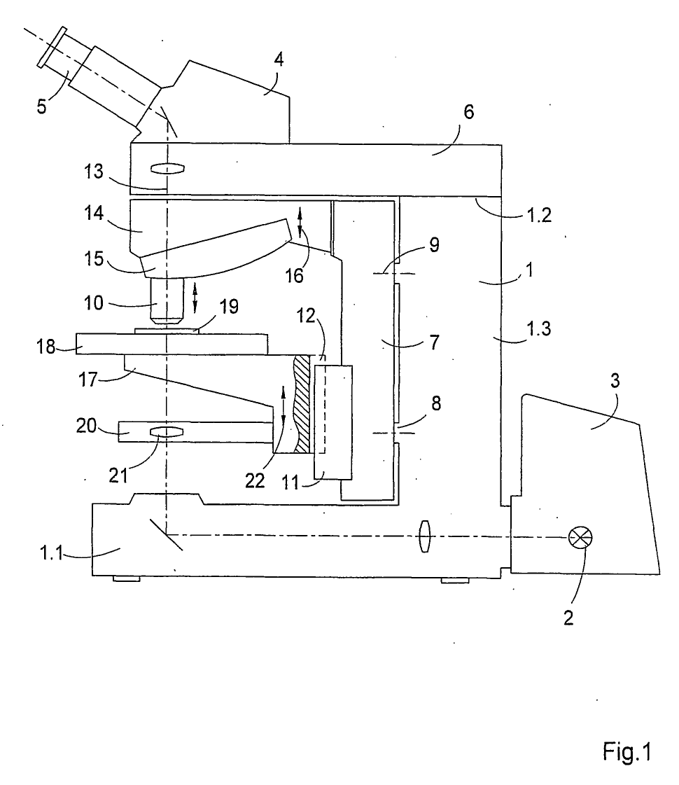

FIG. 1 is a highly simplified view showing the construction of an upright microscope which comprises a base body or stand 1 at which an illumination device 3 comprising a light source 2 is arranged in the bottom area 1.1. An arm 6 supporting an eyepiece receptacle 4 with an eyepiece 5 is arranged at the top end 1.2 of the stand 1. As can also be seen from FIG. 1, a supporting cell 7 which is optimized with respect to material and rigidity is advantageously rigidly arranged at the middle part 1.3 of the stand 1 as a separate assembly, preferably so as to contact projections 8 of the stand 1. In this connection, it is advantageous when the supporting cell 7 is arranged at the stand 1 rigidly, but also in such a way that it can be exchanged, i.e., detached, at any time in order to make changes on the microscope depending upon the task at hand. Screws, clamps or other suitable devices can be provided as fastening means 9, illustrated in dash-dot lines in FIG. 1. These fastening means 9 must ensure a rigid connection between the stand 1 and the supporting cell 7. However, they must also be detachable so that the supporting cell 7 can be exchanged if necessary. In this respect, it can be advantageous when damping intermediate layers and/or intermediate layers which isolate vibrations are arranged between the supporting cell 7 and the contact surfaces of the projections of the stand 1. The supporting cell 7 can also be arranged at the stand 1 in a springing manner.

First assemblies for receiving, holding and adjusting one or more objectives 10 are arranged at the supporting cell 7. Accordingly, the supporting cell 7 has guide components, e.g., in the form of a guide plate 11 which cooperates with suitable guide elements 12 of other microscope assemblies, allowing these assemblies to be adjusted in direction of the optical axis 13 of the objective 10. These first assemblies can also comprise a holder 14 at which is arranged an objective changer device constructed as an objective turret 15. The first assemblies can also comprise a focusing device for focusing the objective changer device. It can be advantageous for purposes of aligning and adjusting the individual assemblies when the holder 14 is fastened to the supporting cell 7 so as to be adjustable and focusable (indicated by the double-arrow 16 in FIG. 1).

Further, second assemblies are arranged at the supporting cell 7 which comprise a stage support 17, a stage guide, and a stage 18 which is arranged on the stage support 17 and is the actual microscope stage on which the object 19 to be examined is positioned. The stage guide comprises the guide plate 11 and the guide elements 12, is advantageously constructed as a compact and rigid unit, and allows the stage support 17 to be displaced (illustrated by the double-arrow 22 in FIG. 1) in direction of the optical axis 13 of the microscope and, therefore, also allows the object 19 arranged on the stage 18 to be displaced relative to the objective 10. The object 19 to be examined can also be brought into focus in this way.

As is shown in FIG. 1, means 20 for arranging a condenser 21 in the illumination beam path of the microscope are located in the lower area of the stand 1 at the stage support 17.

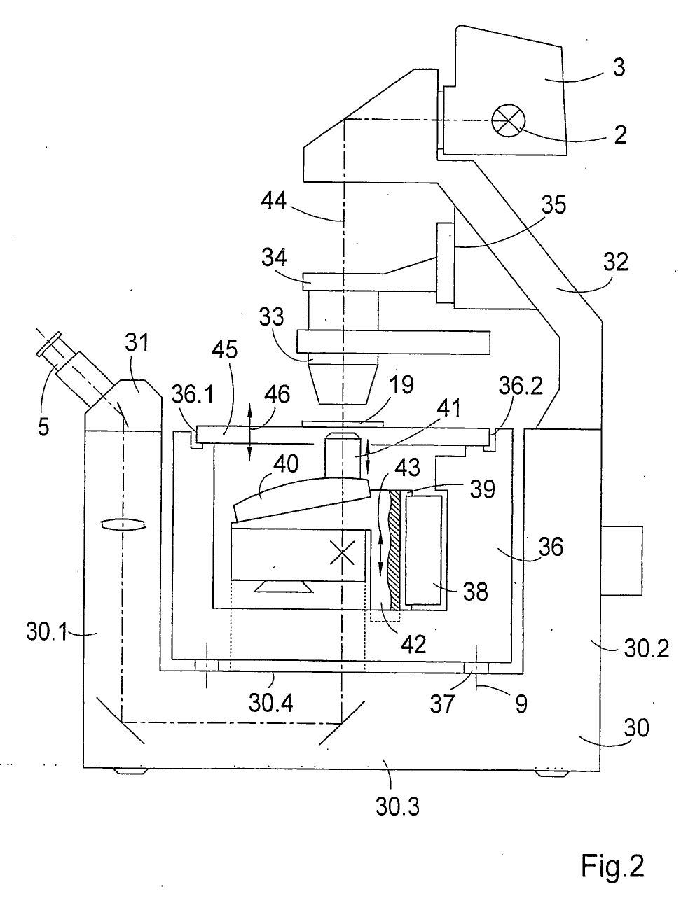

The inverted microscope shown schematically in FIG. 2 has a U-shaped base body or stand 30. An eyepiece receptacle 31 with eyepiece 5 is provided at one leg 30.1 of the stand 30 and a holding arm 32 for the illumination device 3 with light source 2 and for a condenser 33 is provided at its other leg 30.2. The condenser 33 is arranged in a suitable manner in a condenser holder 34 which is displaceable in a guide 35 of the holding arm 32 for the purpose of adjustment.

As can be seen from FIG. 2, a supporting cell 36 is located between the two legs 30.1 and 30.2 of the stand 30 and is rigidly but exchangeably fastened by suitable fastening means 9 to projections 37 of the middle part 30.3 of the stand 30 in the same way as in the microscope according to FIG. 1. In order to prevent or extensively limit vibrations and/or shocks caused by external forces or by internal drives arranged in the stand 30, springing and/or damping intermediate layers (not shown in FIG. 2) can be provided between the contact surfaces of the projections 37 of the stand 30 and the supporting cell 36. The supporting cell 30 has a guide plate 38 in operative connection with guide elements 39 of a holder 42 supporting an objective turret 40 with objectives 41. The displacement directions of the holder 42 supporting the objective turret 40 in direction of the optical axis 44 relative to the stage 45 of the inverted microscope, which stage 45 is likewise arranged at the supporting cell 36, are indicated by the double-arrow 43. The objective 42 is focused on the object 19 located on the stage 45 by means of this adjustment of the objective 41 relative to the stage 45. This stage 45 is mounted rigidly or, for purposes of possible stage focusing, so as to be adjustable in direction of the optical axis 44 (indicated by the double-arrow 46) in guides 36.1 and 36.2 of the supporting cell 36.

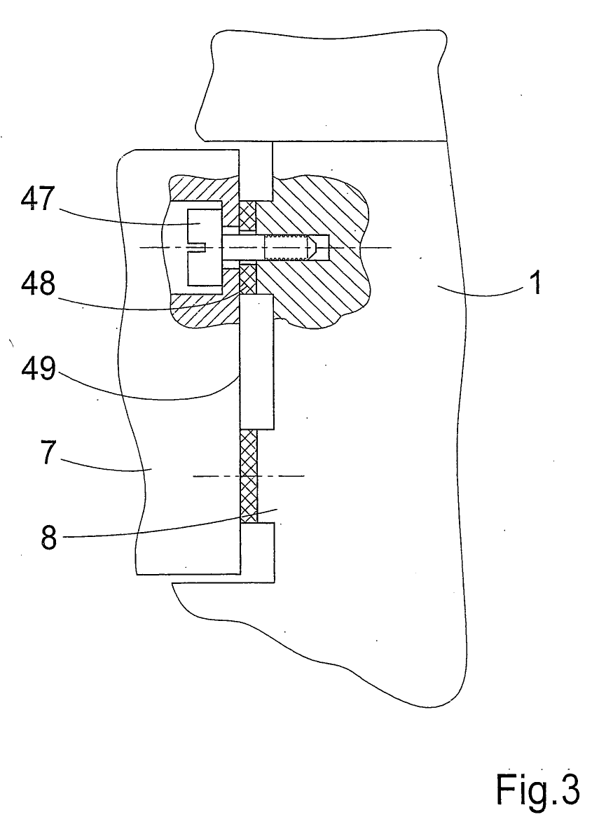

FIG. 3 shows details of the fastening of the supporting cell 7 to the stand 1 of the upright microscope. Screws 47, for example, are provided as fastening means for fixing the supporting cell 7 so that a detachable connection is achieved between the components in question. Other suitable connecting means by which a detachable connection can be realized can also be provided. In order that transmission of shocks and/or vibrations from the stand 1 to the supporting cell 7 with its components is prevented as far as possible, a flexible intermediate layer 48 of suitable material is also arranged between the projection 8 of the stand 1 and the contact surface 49 of the supporting cell 7 for vibration damping. Damping intermediate layers (not shown in FIG. 2) can also be provided between the projections 37 and the contact surface 30.4 of the supporting cell 36 in the inverted microscope according to FIG. 2. The supporting cell 7; 36 itself can be optimized with respect to its dimensions and mass and its material may be substituted for additional dynamic and thermal optimization. For example, the supporting cell 7; 36, or parts thereof, can be made of or can include a thermally invariant material, ceramic material, sintered material or other suitable material or a combination of such materials. Rigidity and thermal stability are increased through the use of ceramic materials for the supporting cell 7; 36 or of steel for the movable guide parts, for example, in particular for certain microscope methods such as time-lapse or optical cutting with a laser scanning microscope (LSM).

Another advantage of a supporting cell 7; 36 constructed in this way consists is that it can be constructed compactly. For example, it can also be used in expanded microscope stands so as to damp vibrations and so as to be free of restriction. In this way, not only can external generation of vibrations be separated, as in modern stand constructions (LSM, wafer inspection microscope), but also internally caused interference resulting, e.g., from accelerated masses in internal drives, can be reduced or eliminated.

While the foregoing description and drawings represent the present invention, it will be obvious to those skilled in the art that various changes may be made therein without departing from the true spirit and scope of the present invention.

### REFERENCE NUMBERS

1 stand
1.1 bottom area
1.2 top end
1.3 middle part
2 light source
3 illumination device
4 eyepiece receptacle
5 eyepiece
6 arm
7 supporting cell
8 projection
9 fastening means
10 objective
11 guide plate
12 guide element
13 optical axis
14 holder
15 objective turret
16 double-arrow
17 stage support
18 stage
19 object
20 means
21 condenser
22 double-arrow
30 stand
30.1 leg
30.2 leg
30.3 middle part
30.4 contact surface
31 eyepiece receptacle
32 holding arm
33 condenser
34 condenser holder
35 guide
36 supporting cell
36.1 guide
36.2 guide
37 projection
38 guide plate
39 guide element
40 objective turret
41 objective
42 holder
43 double-arrow
44 optical axis
45 stage
46 double-arrow
47 screw
48 flexible intermediate layer
49 contact surface

What is claimed is:

1-11. (canceled)

12. A microscope comprising:
a base body or a stand;
a stage support;
a guide for adjusting the stage support or an objective changer device with inserted objectives; and
a stage for holding the object or specimen;
said microscope further comprising:
a supporting cell being provided and being connected to the stand, preferably rigidly but so as to be exchangeable; and
a first assembly being provided for receiving, holding and adjusting the objective and a second assembly being provided for positioning the object or specimen relative to the objective, said first and second assembly are attached to said supporting cell.

13. The microscope according to claim 12, wherein the supporting cell is rigidly fastened to a plurality of projections of the stand.

14. The microscope according to claim 13, wherein damping and/or vibration-isolating intermediate layers are arranged between the supporting cell and the contact surfaces of the projections of the stand.

15. The microscope according to claim 12, wherein the supporting cell is arranged at the stand in a springing manner.

16. The microscope according to claim 12, wherein the first assembly is designed as an objective changer device and/or as an objective focusing device.

17. The microscope according to claim 12, wherein the second assembly comprises a stage support, a stage guide, and a stage.

18. The microscope according to claim 12, wherein the supporting cell is optimized with respect to rigidity, use of material, dimensioning and thermal behavior while adhering to requirements for high stability and imaging quality of the microscope.

19. The microscope according to claim 12, wherein an objective changer device constructed as an objective turret is arranged at the supporting cell.

20. The microscope according to claim 12, wherein means for arranging a condenser are provided at the stage support.

21. The microscope according to claim 12, wherein the stage guide has a guide plate that is fixedly arranged at the supporting cell and guide elements at the stage support which are in an operative connection with the guide plate.

22. The microscope according to claim 12, wherein the supporting cell comprises a thermally invariant ceramic material, sintered material or other suitable material or a combination of such materials.
